(19) United States
(12) Patent Application Publication
(10) Pub. No.: US 2012/0136813 A1
(43) Pub. Date: May 31, 2012

(54) METHOD OF PATTERN RECOGNITION IN A SIGNAL

(75) Inventors: Julien Caroux, Colmar-Berg (LU); Dmitry Grigoryev, Saint-Petersberg (RU)

(73) Assignee: The Goodyear Tire & Rubber Cmpany, Akron, OH (US)

(21) Appl. No.: 12/956,192

(22) Filed: Nov. 30, 2010

(51) Int. Cl. G06F 15/18; G06N 5/02

(52) U.S. Cl. 706/12; 706/46; 706/52

(57) ABSTRACT

The invention is directed to a method for pattern recognition in a signal corresponding for example to the steering angle of a vehicle for testing tires. The method comprises three major steps, namely step a) consisting in identifying phases in the signal by detecting phase changes; step b) consisting in classifying at least some of the identified phases based on their shapes and step c) consisting in detecting the presence of predetermined patterns in the signal where each predetermined pattern corresponds to a specific sequence of classes of phases. The phase changes are determined by extrema of the signal and its first derivative. The classification of the phase is made by means of parameters of the phases, namely the length dL, the amplitude dH, and a form factor S. The definition of the different classes is adjusted in a parameter space by means of manual recognition of maneuvers.

### FIELD OF THE INVENTION

The invention is directed to a method of pattern recognition in a signal. More particularly, the invention is directed to a method of recognition of specific patterns representative of common or typical behaviors in a signal recorded in a measurement activity. Specifically, the measurement activity can be in a driving operation of a vehicle for carrying some tests, the signal recorded being for example the steering wheel angle. The signal recorded comprises lots of useful and not useful information and the method is directed to the identification of the representative sections or patterns of the signal. The measurement activity can be of any other kind where a measurement is made and recorded as a signal from which interesting patterns, sequences or sections are to be extracted in order to be exploited in a further analysis.

### BACKGROUND OF THE INVENTION

One-dimensional (1-D) signals are the most common measurements made during testing and observation of many processes. The state of the process is monitored by one or several one-dimensional signals representing parameter changes of the process as a function of one variable, usually time. During the monitoring, a number of events of particular interest can occur. These events are distributed among a finite number of events and usually conform to a specific pattern in the measured signal. In order to recognize this event, an adequate method or algorithm is needed.

A number of approaches aimed at pattern recognition and detection are described in the literature:

In Arati Gerdes—“Automatic Maneuver Recognition in the Automobile: the Fusion of Uncertain Sensor Values using Bayesian Models”, WIT 2006, Hamburg, the author a developed a Bayesian probabilistic system for automatic maneuver recognition.

In Kari Torkkola, Srihari Venkatesan, and Huan Liu—“Sensor Selection for Maneuver Classification”, 2004, the authors present simulator experiments in determining what sensors make classification of driving states into such maneuvers possible, using various machine learning techniques. Their findings indicate that a small number of derived sensor signals can accomplish the task.

Both approaches rely on a priori probabilities which vary from tire to tire. Also both studies have found that maneuver recognition probability would improve with information from additional sources, like distance to precedent car, road markings detection, etc. Using corresponding instrumentation on the test vehicle would drastically increase the equipment costs as well as the personal costs due to the complexity of operation.

In C. H. Chen—“Digital Waveform Processing and Recognition”, CRC Press, 1982, p. 75-90, a syntactic approach is developed, consisting in dividing the complex pattern in smaller, simpler parts, recognizing those parts and then recognizing the initial pattern as a sequence of its part. The initial recognition problem is thus replaced by several simpler recognition problems. Although the recognition of each single sub-pattern is an easy task, the amount of work to recognize all sub-patterns of all maneuvers appears to be high.

### SUMMARY OF THE INVENTION

The invention consists in a method of pattern recognition in a signal, comprising the following steps: identifying phases in the signal by detecting phase changes; classifying at least some of the identified phases based on their shapes; detecting the presence of predetermined patterns in the signal where each predetermined pattern corresponds to a specific sequence of classes of phases.

According to another aspect of the invention, step a) is based on the detection of extrema of the signal.

According to a further aspect of the invention, step a) is based on the detection of extrema of the first derivate of the signal. Preferably, the step a) is based on the detection of extrema of the signal and of its first derivative.

According to a still further aspect of the invention, step b) is based on at least two parameters of the phase. Preferably, step b) is based on three parameters of the phase.

According to a still further aspect of the invention, step b) is based on the amplitude and the length of the phase.

According to a still further aspect of the invention, step b) is based on the ratio amplitude/length or any function thereof of the phase, and the product amplitude by length or any function thereof of the phase. Preferably, the parameters of step b) comprise the logarithm of the ration amplitude/length and the logarithm of the product amplitude by length of the phase.

According to a still further aspect of the invention, step b) is based on a shape factor of the phase signal.

According to a still further aspect of the invention, the shape factor is the integral of the amplitude of the signal on the length of the phase.

According to a still further aspect of the invention, step b) is based on the convexity of the phase. Various parameters characterizing the convexity of a section of signal are indeed available and can be chosen depending, for example, on the nature of the signal to be treated.

According to a still further aspect of the invention, step b) comprises classifying sequences of at least two consecutive phases.

According to a still further aspect of the invention, the method further comprises a prior training step where values and/or ranges of values of the parameters of the signal are associated to each class. This training step can be carried out also afterwards in order to improve the parameter settings.

According to a still further aspect of the invention, the values of the phase parameters for each class are delimited in a parameter space by boundaries which move during the training. These boundaries are preferably lines which are defined by means of parameters which allow some parallel movement of these lines in the parameter space.

According to a still further aspect of the invention, the training step comprises a statistical analysis of the phases of a representative master signal where classes are allocated only to the most frequent phase shapes, the less frequent phase shapes being ignored. This step can be made for sequences of two consecutive phases since the shape of the signal directly preceding a phase is statistically linked to the shape of the phase.

According to a still further aspect of the invention, the training step comprises allocating classes to most frequent sequences of at least two consecutive phases.

According to a still further aspect of the invention, step c) comprises recognizing a predetermined pattern when the specific sequence of classes corresponding to the pattern is present at least to a certain degree in the identified sequence of classes.

According to a still further aspect of the invention, the method further comprises an evaluation step where the pattern(s) of one or several maneuvers are manually recognized in order to determine the correctness of classification of the different phases according to step b) and, based on this determination, to calculate probabilities of correct detection of the different classes of phases.

According to a still further aspect of the invention, during the manual recognition of the pattern of a maneuver, Pₜᵣᵤₑ the probability of correct detection of a phase of a given class representative of the pattern is calculated as follows:

$${P}_{true} = \frac{{N}_{good}}{[ {( N ]}_{good} + {N}_{outsider} )} ;$$

where N_{good} is the number of phases manually recognized and classified by step b) as the given class; N_{bad} is the number of classes not present in the pattern and not classified by step b) as the given class; N_{outsider} is the number of classes manually recognized and not classified by step b) as the given class, N_{intruder} is the number of classes not present in the pattern and classified by step b) as the given class.

According to a still further aspect of the invention, Pₜᵣᵤₑ is calculated for several classes representative of the pattern.

According to a still further aspect of the invention, the parametric definition of classes representative of the manually recognized pattern is adapted in order to maximize Pₜᵣᵤₑ for each class.

According to a still further aspect of the invention, the probability of false detection of a phase of the given glass P_{false} is calculated as follows:

$${P}_{false} = \frac{{N}_{intruder}}{[ {( N ]}_{bad} + {N}_{intruder} )} .$$

### BRIEF DESCRIPTION OF THE SEVERAL VIEWS OF THE DRAWING

FIG. 1 depicts a phase in a signal, the phase being delimited by two phase changes max(f(f)) and max(df(t)/dt).

FIG. 2 illustrates different parameters of the phase of FIG. 1.

FIG. 3 illustrates different typical shapes of two consecutive shapes of a signal corresponding to the steering angle of a vehicle.

FIG. 4 is the representation in a parameter space of two parameters of the phases and of the region occupied by phases of a specific class.

FIG. 5 is the representation of the manually recognized phases and the region of a specific class in a parameter space.

FIG. 6 is a flowchart illustrating the main steps of the invention.

### DETAILED DESCRIPTION OF THE INVENTION

An amplitude/time signal corresponding for example the steering angle of a vehicle versus time is recorded. This recording is made for example for tire tests purposes where specific maneuvers are to be identified.

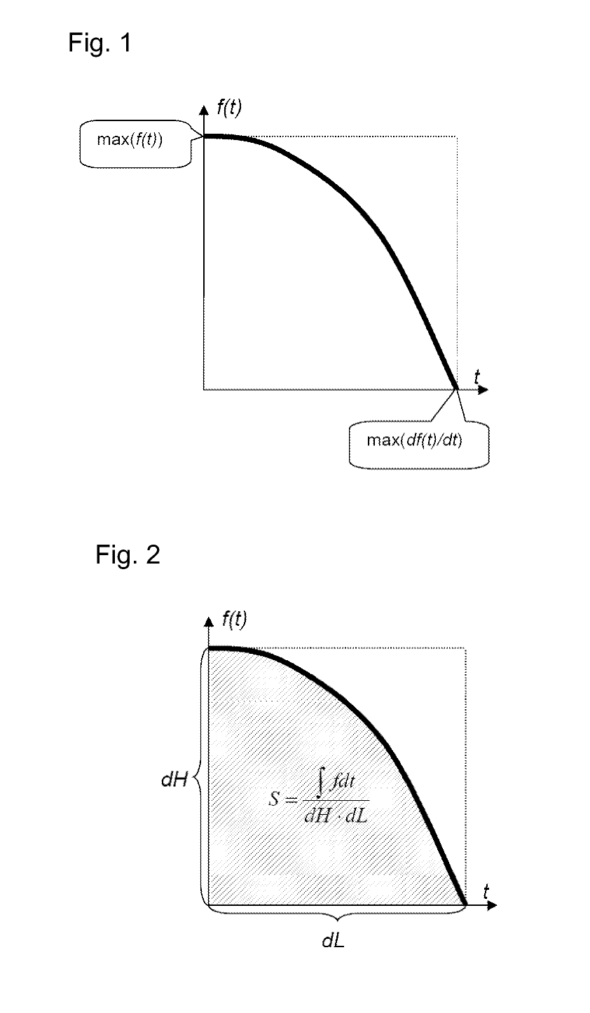

An analysis of this signal is carrying out in order to proceed to patterns recognition. In order to create discrete driving events, a phase detection algorithm is applied to the signal as a first step. A phase is a period of time delimited by the extrema of both the signal f(t) and its first derivative df(t)/dt, as illustrated in FIG. 1. The signal is cut or split at phase changes; these phase changes being either extrema values of the signal or extrema values of the first derivatives. In other words, this means that the signal is cut at all maximum and minimum points as well as at all inflection points. Since these two criteria correspond to changes in concavity of the signal, it can be expected that each phase of signal comprises a single concavity. For a better understanding, this operation can be compared to the splitting of handwritings into letters.

It shall be mentioned here that the use of the extrema of both the signal and of its first derivative is purely exemplary. Indeed, depending on the morphology of the measured signal, other criteria can be considered. For example, it might be appropriate to use as criterion only the extrema of the signal without considerations of the first derivative. In such a case, the phases would be in principle rougher and longer what might be precise enough for recognizing simple or obvious patterns. As another example of alternative, it might be appropriate to split the signal into phases based on the second derivative, resulting in a more precise splitting.

As a second step, the different phases of the signal have to be classified in to order to be analyzed later on. This operation is made on the basis of one or more parameter of the phase. The phase signal illustrated in FIG. 1 shows a single and constant concavity. Based on the above mentioned criteria (max(f(f)) and max(df(t)/dt)), it can be deducted that any phase of signal detected on that basis will be comprised within a rectangle delimited by the tangential to the signal at the point max(f(f)) and a parallel thereto passing at the point max(df(t)/dt). The rectangle is also delimited by a perpendicular to the tangential and passing at the point max(df(t)/dt) and a parallel thereto passing at the point max(f(f)). As is illustrated in FIG. 2, the phase of signal can be characterized by the length of the two sides of the rectangle, i.e. dL the length or lapse of time of the phase, and dH the amplitude or height of the phase signal.

Although the two parameters dL and dH are representative and discriminatory parameters of the signal in the phase, the signal can still take various shapes while said parameters remaining the same. For example, an imaginary phase passing at the same extreme points max(df(t)/dt) and max(f(f)), but with an opposite concavity would still be characterized by the same values of the parameters dL and dH as the phase of FIGS. 1 and 2. For such an imaginary phase the extreme points max(df(t)/dt) and max(f(f)) would be reversed but this phase would still meet the criteria of the phase as described above and be characterized by the values of dL and dH. Since the concavity of the phase is considered to be important for the pattern recognition, a further parameter representative of the shape of the signal within the rectangle has been defined as the area S covered by the signal in the phase. This area is illustrated as a dashed area in FIG. 2 and is calculated as follows:

$$S = \frac{{\int }_{0}^{dt} f d t}{d H \cdot d L}$$

The three parameters dL, dH and S are found to be representative of the signal and with a low correlation level.

More generally speaking, the parameters characterizing the signal should be chosen in such a way that:

They closely represent geometric features of the signal and they can be assessed visually.

They allow noise-tolerant signal reconstruction.

They are independent of signal offsets and from signal sign. Applied to a signal corresponding to a steering angle of a vehicle; this means that parameters are tolerant to constant road curvatures (independent of signal offset) and can be used to describe both left and right maneuvers.

The three parameters described here above fulfill indeed these criteria. More particularly, the area factor S has the ability to be noise tolerant in that any noise of higher frequency will not have any noticeable influence on this factor. The reconstruction of a signal affected by such noise, based on dH, dL and S by means of a polynomial function will provide a noise free reconstructed signal.

The different phases identified can be classified by means of the above mentioned parameters. Depending on the nature of the signal to be treated, some phase classes are more frequent than others, so that it can be efficient and appropriate to neglect some types of phase and to allocate a class only to the phases corresponding to frequent and/or representative classes. This can be much dependent on the nature of the signal to be treated.

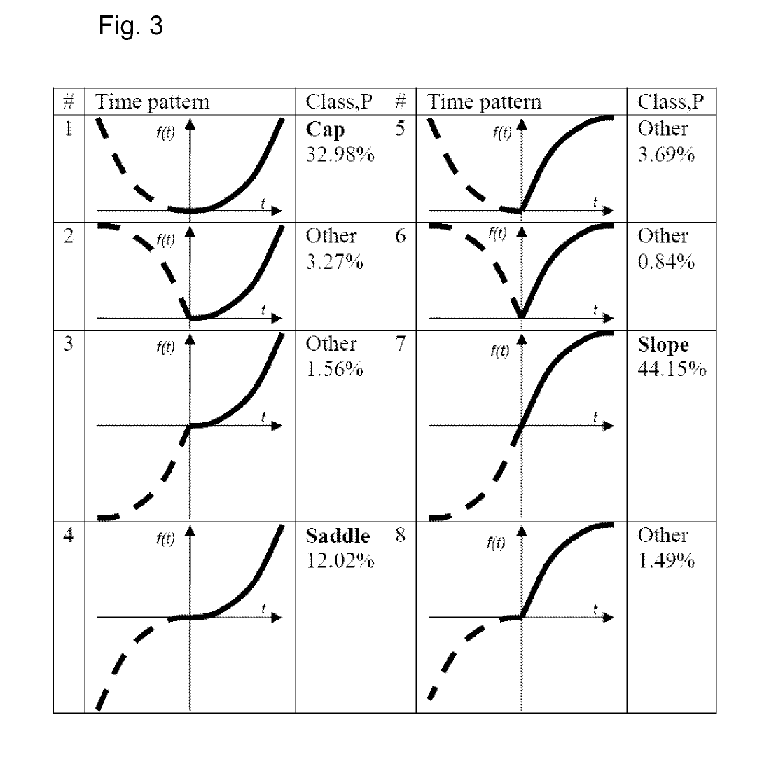

One option for simplifying the classification and reducing the number of classes is to consider a sequence of two consecutive phases according to the definition made above. The analysis is then based on the type of convexity of the current phase and its predecessor. It is therefore an analytical classification based on geometrical features. The goal is to distinguish different parts of a wave, regardless of the sign of the derivative. This permits to identify parts of steering maneuver for both left and right directions. Four types of convexity for each phase give 16 possible combinations for a 2-phase sequence. As the sign of the derivative is not taken into account, 8 cases remain. These cases are represented in FIG. 3. A statistical analysis of the phases illustrated in FIG. 3 on the basis of a signal corresponding to the steering angel of a vehicle has yielded the percentage indicated in the column named “Class, P”. These percentages correspond to probabilities P of presence of the different classes in a master signal.

The first class (#1) with a cap shape is found to occur at 32.98%, i.e. at a high rate. This shape of signal corresponds indeed to a natural movement of inversion of the rotation direction of the steering wheel.

The fourth class (#4) with a saddle shape corresponds to a movement of continuous rotation of the steering wheel with a slight slow-down section (centered at f(t)=0). This corresponds to a natural common movement of the steering wheel and is found to occur at a rate of 12.02%.

The seventh class (#7) with a slope shape is similar in shape to the fourth one whereas the rotation speed is approximately constant at the center portion of the signal whereas the rotation speed is slower at the beginning and the end of the signal. This corresponds also to a natural movement of the steering wheel while driving the vehicle and shows therefore a high rate of 44.15%.

The classes #2, 3, 6 and 8 show an inflexion point (at f(t)=0) with no derivative. The class #5 shows also a point (at f(t)=0) with no derivative. Physically, these classes correspond to movements of the steering wheel which do not correspond to common movements of maneuvers. This explains the very low frequency of these shapes of signal.

Among the identified 8 classes for 2-phase sequences, only three classes will be considered, i.e. classes #1 (cap), 4 (saddle) and 7 (slope) in view of their recurrences. In practice, only these three classes can be found in a continuous signal after filtering. The other classes correspond generally to smaller phases and are rejected.

A more precise classification can be done when considering more parameters. In the case of the signal of the steering angle of a vehicle, the parameter space of the different phases is convex, meaning that it does not show any self-organization of the classes. In order to have classification results which can be exploited, a training-based approach or calibration has been used.

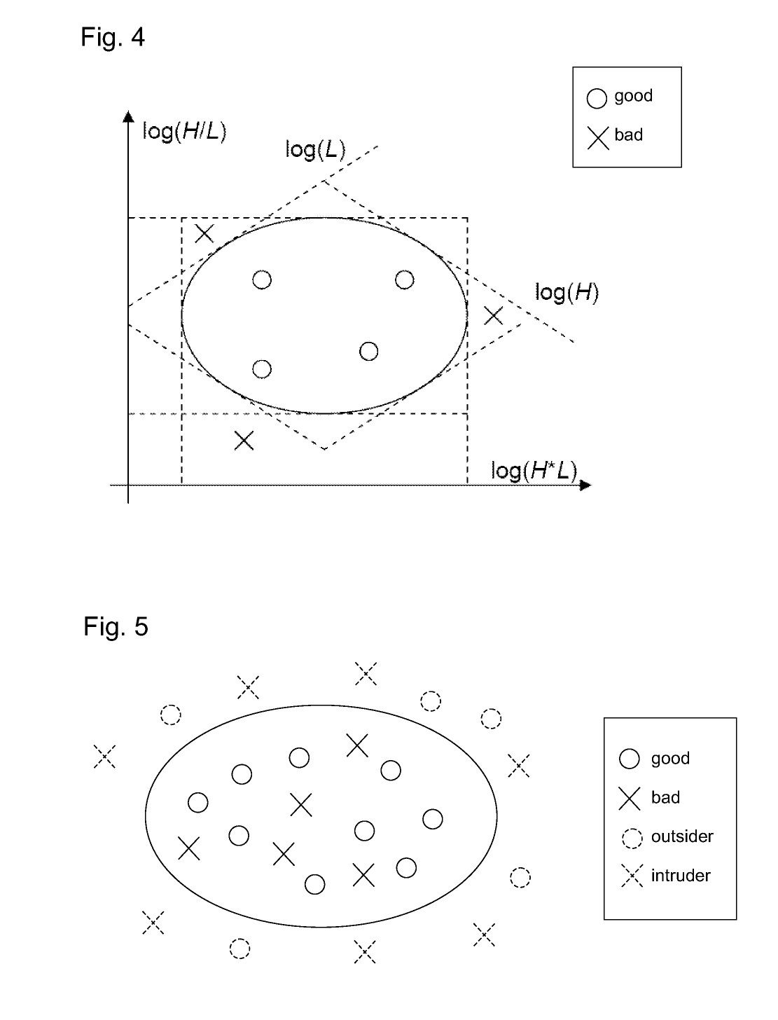

Several runs were chosen for training purposes and maneuvers in these runs were recognized manually with the help of experts. Phases of these maneuvers have then been manually attributed to classes, resulting in the definition of regions in the parameter space defining the different classes of the classification scheme. Such a region is illustrated in FIG. 4 showing a parameter space with two coordinate axes, one for the function log(H·L) and one for the function log(H/L). The different points illustrated by circles and crosses correspond to different phases in this specific parameter space. The points represented by a circle correspond to phases belonging to the same class, this class being represented by the ellipse. The points represented by a cross correspond to phase of a different class or at least not belonging to the class in question.

The parameters log(H·L) and log(H/L) have been chosen for they show a very low level of correlation. The introduction of one or more parameters would of course increase the accuracy of classification. When selecting parameters, it is generally appropriate to consider parameters with a low level of correlation with each other in order to increase their discriminatory effect.

The boundaries of the regions of the different classes can be initially roughly set by means of lines as illustrated in FIG. 4. Indeed, the region or area where so-called “good” points for a manually identified class can be delimited by vertical, horizontal and oblique lines in the parameter space. FIG. 4 illustrates four “good” points and two “bad” points. The four “good” points are delimited by four line, where two of them are parallel to the first coordinate axis log(H·L) and the two others are parallel to the second coordinate axis log (H/L). It can be observed that the rectangle area delimited by these lines includes a “bad” point (in the upper left corner). Four additional parallel oblique lines are also present. Two of them are parallel and correspond to a function log(L) and the two others are also parallel and correspond to the function log(H). It can be observed that the region delimited by these lines and by the rectangle now excludes the “bad” point, i.e. thereby increasing the accuracy of the definition of the class. It is indeed important not to include “bad” points in the definition of class in order to avoid a false classification which might lead to false pattern detection.

It can be appropriate to consider improving the boundaries of the classes by means of further training sessions. Indeed, this can be done in a partly automated manner in that some parameters of the lines discussed here above are adapted in an iterative way to take into consideration further points manually identified during a further training session. The mathematical functions of the log(L) line and its parallel have log(H·L) as variable so that they differ only in by a parameter value (log(H·L)=log(H)+log(L), meaning that log(L)=log(H·L)−log(H)). The parameter values of these lines can therefore be adapted iteratively during such further training sessions.

The third major step of the method is the pattern recognition, more precisely expressed, the sequence detection. Indeed a pattern is a sequence of phases which have to be detected by the algorithm. It resembles to a simple text search, where a longer sequence of letters (text) is searched for occurrences of a shorter sequence (word).

The recognition performance of the algorithm can be assessed and improved by training sessions. As some maneuvers can be recognized manually in a training session, the points corresponding to their phases form some shapes in the parameter space, and regions are defined to approximate these shapes. This is illustrated in FIG. 5. The points illustrated with circles and crosses in FIG. 5 correspond to phases identified. The boundary region represented by an oval form or ellipse corresponds to a class which corresponds to the manually recognized maneuver. Points corresponding to phases which belong to the pattern are called “good” points and are represented by a circle. The points corresponding to phases which do not belong to the pattern are called “bad” points and are represented by a cross. The “good” points which are outside the ellipse are called “outsider” points and are represented in dashed line. The “bad” points which are inside the ellipse are called “intruder” points and are represented also in dashed line. In practice, this means that the detection of a maneuver or pattern is based on a reduced number of phase shapes as the maneuver normally includes. In others words and in reference to the comparison with the detection of handwriting, this means that a word or a letter would be detected by too narrow definitions of the shape of the different letters. The narrow definitions will exclude some “good” letters but will exclude most of the wrong ones in order to minimize the risk of false detection.

For each point or phase, two probabilities are defined with respect to the number of points in each category (good, bad, intruder and outsider):

$${P}_{true} = \frac{{N}_{good}}{[ {( N ]}_{good} + {N}_{outsider} )} ; {P}_{false} = \frac{{N}_{intruder}}{[ {( N ]}_{bad} + {N}_{intruder} )} ;$$

where Pₜᵣᵤₑ P is the correct detection probability for a given phase; P_{false} is the false detection probability for a given phase; N_{good} is the number of manually recognized phases located within the ellipse; N_{bad} is the number of phases found not to be present in the manually recognized maneuver and outside the ellipse; N_{outsider} is the number of manually recognized phases outside the ellipse; and N_{intruder} is the number of phases found not to be present in the manually recognized maneuver and inside the ellipse.

Pₜᵣᵤₑ can be considered independent of the percentage of manually recognized maneuvers. If N_{intruder} is big enough, we can also consider P_{false} also to be independent of manual recognition. But technically, P_{false} is dependent on the manual recognition because more “good” points mean fewer “intruder” points.

For any given maneuver M which is composed of n phases p₁, . . . , pₙ, we have Pₜᵣᵤₑ(M)=Pₜᵣᵤₑ(p₁)× . . . +Pₜᵣᵤₑ(p₁).

Again, the same formula is not true for P_{false}, as false phase detection cannot be considered independent or perfectly random. But at least we can say that P_{false}(p₁)× . . . ×P_{false}(pₙ)<P_{false}(M)<min(P_{false}(p₁), . . . , P_{false}(pₙ)).

These probabilities are used for evaluating the recognition performance.

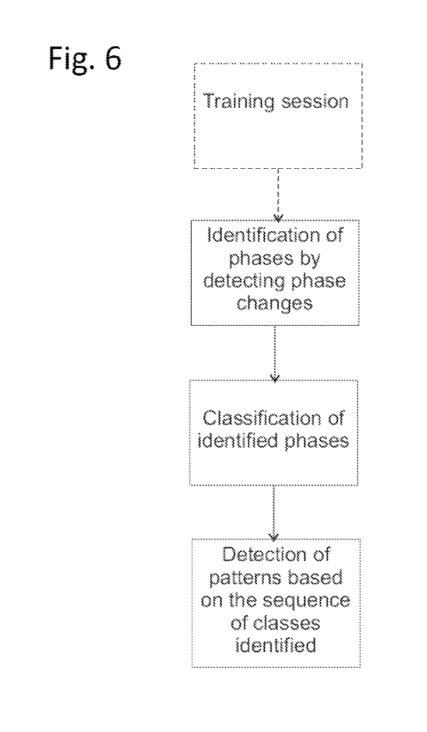

The general flowchart of the method is illustrated in FIG. 6 which shows the succession of the three major steps preceded by a prior calibration or training step. As mentioned before, training sessions can be carried out afterwards in order to assess the performance of recognition and to improve the parameters settings of classification of the phases.

While the invention has been described with respect to a limited number of embodiments or examples, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their equivalents.

1. Method of pattern recognition in a signal, comprising the following steps:
a) identifying phases in the signal by detecting phase changes;
b) classifying at least some of the identified phases based on their shapes; and
c) detecting the presence of predetermined patterns in the signal where each predetermined pattern corresponds to a specific sequence of classes of phases.

2. Method of pattern recognition in a signal according to claim 1, wherein step a) is based on the detection of extrema of the signal.

3. Method of pattern recognition in a signal according to claim 1, wherein step a) is based on the detection of extrema of the first derivate of the signal.

4. Method of pattern recognition in a signal according to claim 1, wherein step b) is based on at least two parameters of the phase.

5. Method of pattern recognition in a signal according to claim 4, wherein step b) is based on the amplitude and the length of the phase.

6. Method of pattern recognition in a signal according to claim 5, wherein step b) is based on the ratio amplitude/length or any function thereof of the phase, and the product amplitude by length or any function thereof of the phase.

7. Method of pattern recognition in a signal according to claim 5, wherein step b) is based on a shape factor of the phase signal.

8. Method of pattern recognition in a signal according to claim 7, wherein the shape factor is the integral of the amplitude of the signal on the length of the phase.

9. Method of pattern recognition in a signal according to claim 7, wherein step b) is based on the convexity of the phase.

10. Method of pattern recognition in a signal according to claim 5, wherein step b) comprises classifying sequences of at least two consecutive phases.

11. Method of pattern recognition in a signal according to claim 4, further comprising a prior training step where values and/or ranges of values of the parameters of the signal are associated to each class.

12. Method of pattern recognition in a signal according to claim 11, wherein the values of the phase parameters for each class are delimited in a parameter space by boundaries which move during the training.

13. Method of pattern recognition in a signal according to claim 11, wherein the training step comprises a statistical analysis of the phases of a representative master signal where classes are allocated only to the most frequent phase shapes, the less frequent phase shapes being ignored.

14. Method of pattern recognition in a signal according to claim 13, wherein the training step comprises allocating classes to most frequent sequences of at least two consecutive phases.

15. Method of pattern recognition in a signal according to claim 1, wherein step c) comprises recognizing a predetermined pattern when the specific sequence of classes corresponding to the pattern is present at least to a certain degree in the identified sequence of classes.

16. Method of pattern recognition in a signal according to claim 4, further comprising an evaluation step where the pattern(s) of one or several maneuvers are manually recognized in order to determine the correctness of classification of the different phases according to step b) and, based on this determination, to calculate probabilities of correct detection of the different classes of phases.

17. Method of pattern recognition in a signal according to claim 16, wherein during the manual recognition of the pattern of a maneuver, Pₜᵣᵤₑ the probability of correct detection of a phase of a given class representative of the pattern is calculated as follows:
$${P}_{true} = \frac{{N}_{good}}{[ {( N ]}_{good} + {N}_{outsider} )} ;$$
where N_{good} is the number of phases manually recognized and classified by step b) as the given class; N_{bad} is the number of classes not present in the pattern and not classified by step b) as the given class; N_{outsider} is the number of classes manually recognized and not classified by step b) as the given class, and N_{intruder} is the number of classes not present in the pattern and classified by step b) as the given class.

18. Method of pattern recognition in a signal according to claim 17, wherein Pₜᵣᵤₑ is calculated for several classes representative of the pattern.

19. Method of pattern recognition in a signal according to claim 17, wherein the parametric definition of classes representative of the manually recognized pattern is adapted in order to maximize Pₜᵣᵤₑ for each class.

20. Method of pattern recognition in a signal according to claim 17, wherein the probability of false detection of a phase of the given glass P_{false} is calculated as follows:
$${P}_{false} = \begin{matrix}{N}_{intruder} \\ [ {( N ]}_{bad} + {N}_{intruder} ) .\end{matrix}$$
